(19) United States
(12) Patent Application Publication
(10) Pub. No.: US 2011/0287226 A1
(43) Pub. Date: Nov. 24, 2011

(54) Electrically Insulating Body

(76) Inventor: Patrik Roseen, Vasteras (SE)

(21) Appl. No.: 13/197,564

(22) Filed: Aug. 3, 2011

Related U.S. Application Data
(63) Continuation of application No. PCT/EP2009/051186, filed on Feb. 3, 2009.

(51) Int. Cl. B32B 3/00; B29C 45/00; B29C 49/02

(52) U.S. Cl. 428/156; 264/523; 264/328.1

(57) ABSTRACT

An electrically insulating body with a complex shape has a thin-walled shell of first insulating material, the shell interior being filled with a second insulating material. The shell is seamless, and for obtaining the complex shape in seamless construction the shell is manufactured with a special method such as blow moulding.

### CROSS-REFERENCE TO RELATED APPLICATIONS

The present application is a continuation of pending International patent application PCT/EP2009/051186 filed on Feb. 3, 2009 which designates the United States and the content of which is incorporated herein by reference.

### FIELD OF THE INVENTION

The present invention relates to an electrically insulating body with a complex shape. The electrically insulating body has a shell comprising a first insulating material and an interior filled with a second insulating material. The present invention further relates to a method of manufacturing an electrically insulating body.

### BACKGROUND OF THE INVENTION

For the purpose of electrical insulation, electrical components or conductors are either surrounded by an insulating body, or an insulating body is placed between two or more conducting or semiconducting elements. In one conventional insulating method electrical components are cast in a solid block of insulating material. The components are inserted in a mould, and the mould is filled with an insulating material which after curing forms a solid block. This so-called automatic process gelation (APG) method is used e.g. to manufacture indoor current transformers wherein the electrical components comprise primary and secondary windings and the insulating material is epoxy resin.

In an alternative conventional method a thin-walled insulating shell of a thermoplastic material is fabricated by injection moulding, and after inserting the electrical components the interior of the shell is filled with a second insulating material such as epoxy or polyurethane. This manufacturing method is more flexible and fast compared with the APG method because the cycle time for injection moulding of the shells is short, and no mould is needed in the filling stage of the process.

One drawback of using a conventional injection moulding method for manufacturing the insulating shells is that the shells must be relatively simple in shape. A conventional mould comprises at least two separable sides: a cavity and a core, which are separated in order to extract the moulded part. The resulting part has one large opening in the draw direction, i.e. the direction in which the cavity and the core separate from each other. Generally no shapes or features are allowed that would prevent the separation of the mould sides or extraction of the part after moulding. This means that overhanging features, i.e. features that penetrate into the cavity, the core or the shell wall perpendicular to the draw direction, are not allowed. For example, a bottle neck shape is in this context considered as an overhanging feature.

It would often be desirable to give an insulating shell a shape that is more complex than a conventional injection moulding method can obtain. For example, by making the shell shape to better correspond to the size and shape of the contained components, an excess of the surrounding insulating material can be avoided. This leads to both reduced material use and shortened manufacturing time. It is a known method to join two or more simple injection moulded parts by gluing or welding in order to achieve more complex shell shapes. This method results in a seam across the shell walls, and is an unsatisfactory solution in the context of insulators as the seam may negatively affect the insulating properties of the shell. The seam or the glue can comprise air bubbles or impurities, and easily becomes the weak part of the insulating shell decreasing the breakdown voltage value of the whole insulating body. The situation is especially unfavourable if the seam is in a longitudinal direction between two electric potentials, leading to an increased risk of flashover. Even the puncture voltage across the insulating shell is expected to be decreased in the presence of a seam. The seam may also be clearly visible and therefore aesthetically undesirable.

### SUMMARY OF THE INVENTION

One object of the invention is to provide an electrically insulating body with a complex shape and good insulating properties. A further object of the invention is to provide a method of manufacturing an electrically insulating body with a complex shape and good insulating properties.

These objects are achieved by an electrically insulating body comprising a shell and by the method of manufacturing an electrically insulating body.

The invention is based on the identification of the advantages of a complex insulating shell shape. Furthermore, the invention is based on the identification of the drawbacks of assembling the insulating shell of two or more parts, and on the realization that these drawbacks can be avoided by making the insulating shell seamless. A new manufacturing method is necessary for achieving the complex shape with a seamless construction.

According to one embodiment of the invention there is provided an electrically insulating body comprising a shell, the shell comprising a first insulating material, the shell defining a shell interior having at least one overhanging feature, the shell interior being at least partially filled with a second insulating material, wherein the shell is seamless. By using a seamless shell construction, the negative effects of the seam to the insulating properties of the shell are avoided.

According to one embodiment of the invention, the first insulating material is a thermoplastic material. The shell is preferably manufactured by moulding, and thermoplastic materials are insulators with good moulding properties.

According to one embodiment of the invention, the thermoplastic material is a material selected from a group consisting of: nylon, polybutylene terephthalate (PBT), polypropylene (PP), polyethylene (PE) and polyethylene terephthalate (PET). These materials have been found to be the preferred ones among thermoplastic materials.

According to one embodiment of the invention, the thermoplastic material is glass fibre or carbon fibre reinforced. The rigidity of the shell can be increased by using a fibre material, and thinner shell construction is enabled.

According to one embodiment of the invention, the second insulating material is a material selected from a group consisting of: epoxy, polyurethane, silicone gel and oil gel. Because the required volume of the second insulating material can be quite large, it is important to choose a cheap filling material.

According to one embodiment of the invention, the shell is manufactured using a blow moulding method.

According to one embodiment of the invention, the shell is manufactured using an injection moulding method with a collapsing mould core.

The two aforementioned manufacturing methods are alternatives for obtaining the complex shell shape.

According to one embodiment of the invention, the shell interior contains electrical components. By embedding the electrical components in the insulating material the components are protected both electrically and mechanically.

According to one embodiment of the invention, the electrical components constitute a transformer. The present invention is advantageously applied in replacing an existing method of housing transformer components.

According to one embodiment of the invention, there is provided a method of manufacturing an electrically insulating body comprising: providing a mould cavity comprising at least one overhanging feature; using the mould cavity for moulding a seamless shell comprising a first insulating material; filling the seamless shell at least partially with a second insulating material.

### BRIEF DESCRIPTION OF THE DRAWINGS

The invention will be explained in greater detail with reference to the accompanying drawings, wherein

FIG. 1 shows a transformer comprising an electrically insulating body according to one embodiment of the invention, and

FIG. 2 shows a shell corresponding to the electrically insulating body of FIG. 1.

### DETAILED DESCRIPTION OF THE INVENTION

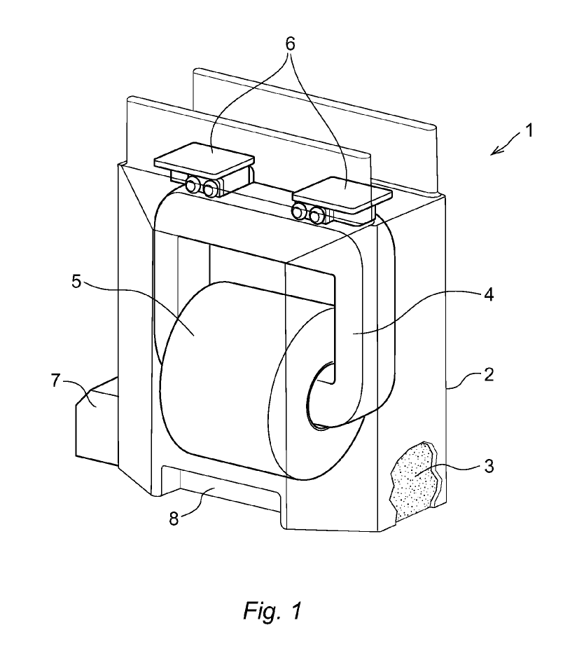

FIG. 1 shows a transformer comprising an electrically insulating body 1 according to one embodiment of the invention. The body 1 houses an indoor current transformer essentially comprising a primary winding 4, a secondary winding 5, clamps 6 for connecting the primary winding 4, and a terminal 7 for connecting the secondary winding 5. The body 1 comprises a shell 2 made of a thermoplastic material, the interior of the shell 2 being filled with a second insulating material 3 such as epoxy, polyurethane, silicone gel or oil gel. The lower edge of the body 1 is provided with handles 8 in the form of a recess on each side of the body 1, the two recesses being incorporated in the shell form.

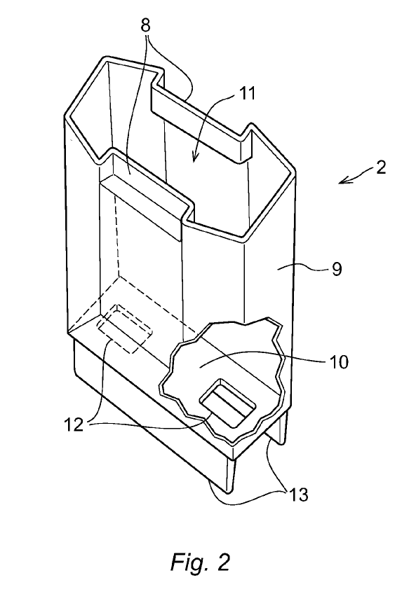

FIG. 2 shows a shell 2 corresponding to the electrically insulating body 1 of FIG. 1. The shell 2 comprises a side wall 9, an end wall 10, an opening 11, two apertures 12, two projections 13 and two handles 8. The handles 8 are in the form of two features protruding inwardly towards the shell interior. From the moulding point of view, the handle features are so-called overhanging features as they penetrate into the mould cavity perpendicular to the draw direction. According to a conventional injection moulding method this type of features would not be allowable because the overhanging features would prevent the extraction of the mould core from the shell 2 after moulding. However, it is possible to mould a shell 2 according to FIG. 2 by using special moulding methods. There are at least the following two moulding methods with which a shell 2 according to FIG. 2 can be obtained: blow moulding and injection moulding with a collapsing mould core. In the following, each of these methods will be described in more detail.

In a blow moulding method the thermoplastic material is melted and formed to constitute a parison, which is a tube-like piece of plastic with a hole in one end. The parison is captured by closing it into a mould cavity, and air is blown into the parison, inflating it into the shape of the mould cavity. After the plastic has cooled sufficiently, the mould is opened and the shell 2 is ejected.

In an injection moulding method with a collapsing mould core the mould core is capable of changing its outer dimensions such that it can be extracted through the shell opening 11 after moulding. This can be obtained e.g. by providing a hollow, flexible core with an inflatable bladder.

The shell 2 resulting from the aforementioned moulding methods has a thin wall 9, 10 in the range of about 0.5 to 5 mm. The wall 9, 10 may be relatively flexible such that the transformer components having a dimension larger than the dimensions of the opening 11 can be inserted by stretching the opening 11 during the assembly. The flexibility can be achieved by dimensioning the wall thickness appropriately and by choosing an appropriate shell material. The shell material can be selected from a group consisting of nylon, polybutylene terephthalate (PBT), polypropylene (PP), polyethylene (PE) and polyethylene terephthalate (PET). The shell material may be reinforced with appropriate material such as glass fibre or carbon fibre.

After the shell 2 is moulded it can be machined in a plurality of ways in order to obtain the final functionality of the shell 2. The transformer of FIG. 1, for example, needs two apertures 12 for the clamps 6 of the primary winding 4. By using an injection moulding method with a collapsing core such apertures 12 can be obtained by appropriate mould design, but when a blow moulding method is used the apertures 12 have to be provided afterwards.

The invention is not limited to the embodiments shown above, but the person skilled in the art may, of course, modify them in a plurality of ways within the scope of the invention as defined by the claims. Thus, for example, the invention is not limited to transformer housings, but may be applied to any other electrical insulation tasks.

1. An electrically insulating body comprising a shell, the shell comprising a first insulating material, the shell defining a shell interior having at least one overhanging feature, the shell interior being at least partially filled with a second insulating material, characterized in that the shell is seamless.

2. The body according to claim 1, wherein the first insulating material is a thermoplastic material.

3. The body according to claim 2, wherein the thermoplastic material is a material selected from a group consisting of: nylon, polybutylene terephthalate, polypropylene, polyethylene and polyethylene terephthalate.

4. The body according to claim 2, wherein the thermoplastic material is glass fibre or carbon fibre reinforced.

5. The body according to claim 1, wherein the second insulating material is a material selected from a group consisting of: epoxy, polyurethane, silicone gel and oil gel.

6. The body according to claim 1, wherein the shell is manufactured using a blow moulding method.

7. The body according to claim 1, wherein the shell is manufactured using an injection moulding method with a collapsing mould core.

8. The body according to claim 1, wherein the shell interior contains electrical components.

9. The body according to claim 8, wherein the electrical components constitute a transformer.

10. A method of manufacturing an electrically insulating body comprising: providing a mould cavity comprising at least one overhanging feature; using the mould cavity for moulding a seamless shell comprising a first insulating material; filling the seamless shell at least partially with a second insulating material.

11. The method according to claim 10 wherein the seamless shell moulded using a blow moulding method.

12. The method according to claim 10 wherein the seamless shell is moulded using an injection moulding method with a collapsing mould core.
